(19) United States
(12) Patent Application Publication
(10) Pub. No.: US 2016/0202127 A1
(43) Pub. Date: Jul. 14, 2016

(54) ELECTRONIC THERMOMETER

(71) Applicant: CliniCloud Inc., San Francisco, CA (US)

(72) Inventors: Hon Weng Chong, Toorak (AU); An Lin, Eight Mile Plains (AU); Lain Cai Cai, Macleod (AU)

(21) Appl. No.: 14/990,530

(22) Filed: Jan. 7, 2016

Related U.S. Application Data
(60) Provisional application No. 62/101,661, filed on Jan. 9, 2015.

(51) Int. Cl. G01J 5/02; G01K 7/02; H04W 76/02; G01J 5/08

(52) U.S. Cl. CPC G01J 5/0265; G01J 5/0896; G01K 7/02; H04W 76/02

(57) ABSTRACT

Embodiments cover an electronic infrared thermometer and a user device that executes a thermometer module. In one embodiment, the electronic infrared thermometer includes a body, a thermopile housed within the body, and a wireless module housed within the body and electrically coupled to the thermopile. The wireless module is configured to receive a first signal from the user device, transition the electronic infrared thermometer out of a low power state responsive to receipt of the first signal and establish a wireless connection with the user device. The wireless module is further configured to receive a second signal from the user device via the wireless connection, cause the thermopile to activate, receive one or more temperature measurements from the thermopile, and transmit the one or more temperature measurements to the user device via the wireless connection.

### RELATED APPLICATIONS

This patent application claims the benefit under 35 U.S.C. §119(e) of U.S. Provisional Application No. 62/101,661, filed Jan. 9, 2015.

### TECHNICAL FIELD

Embodiments of the present invention relate, in general, to electronic thermometers, and in particular to electronic thermometers that operate in conjunction with a thermometer application running on a user device.

### BACKGROUND

Thermometers are used for medical purposes, in industry, in meteorology, and in scientific research. There are multiple different types of thermometers that are available, which may use various means to measure temperature.

### BRIEF DESCRIPTION OF THE DRAWINGS

The embodiments described herein will be understood more fully from the detailed description given below and from the accompanying drawings, which, however, should not be taken to limit the application to the specific embodiments, but are for explanation and understanding only.

FIG. 1 is an exploded view of an electronic thermometer, in accordance with one embodiment.

FIG. 2 is a perspective view of the electronic thermometer of FIG. 1 wirelessly connected to a mobile phone, in accordance with one embodiment.

FIG. 3 is a block diagram illustrating an exemplary user device having a thermometer module installed thereon, in accordance with one embodiment.

FIG. 4 is a block diagram of a thermometer module, in accordance with one embodiment.

FIG. 5 is a flow diagram illustrating one embodiment for a method of controlling an electronic infrared thermometer.

FIG. 6 is a flow diagram illustrating one embodiment for a method establishing a wireless connection with an electronic infrared thermometer.

FIG. 7 is a flow diagram illustrating one embodiment for a method of selecting the unit of measurement for outputting measurements of an electronic thermometer.

FIG. 8 is a flow diagram illustrating one embodiment for a method of operating an electronic infrared thermometer.

FIGS. 9A-9G are various views of a user interface of a thermometer module, in accordance with one embodiment.

FIGS. 10A-C are additional views of a user interface of a thermometer module, in accordance with one embodiment.

### DETAILED DESCRIPTION OF THE PRESENT INVENTION

Described herein are embodiments of an electronic thermometer that pairs to a user device and of a thermometer module that runs on the user device. The electronic thermometer may be connected to the user device via a wired or wireless connection, and may activate, deactivate, and generate diagnostic audio signals based on signals (e.g., radio frequency (RF) signals) received from the user device over the connection. The electronic thermometer may not include any buttons, such as for turning on or off the electronic thermometer or for taking measurements. Instead, the electronic thermometer may rely on signals from the user device to perform such operations.

The user device may include a thermometer module (e.g., a thermometer application or “app”) that enables the user device to communicate with the electronic thermometer and cause the electronic thermometer to operate. The thermometer module may guide a user through the placement and use of the electronic thermometer (e.g., via a series of prompts of a user interface), and may process received temperature measurements to determine a temperature of a patient.

The electronic thermometer may pair to a user device via a wireless protocol such as Bluetooth®, Zigbee® or Wi-Fi®. A head of the electronic thermometer may be placed near or against the temple of a patient. The electronic thermometer may be an electronic infrared thermometer, and may use a thermopile that includes an infrared sensor to generate multiple temperature measurements. The electronic thermometer may transmit these temperature measurements to the user device via a wireless connection. The thermometer module may then process the measurements to determine a temperature of the patient, and may output the temperature with a visual and/or audio indicator via a user interface. Embodiments provide a low cost accurate system for determining the temperature of a patient.

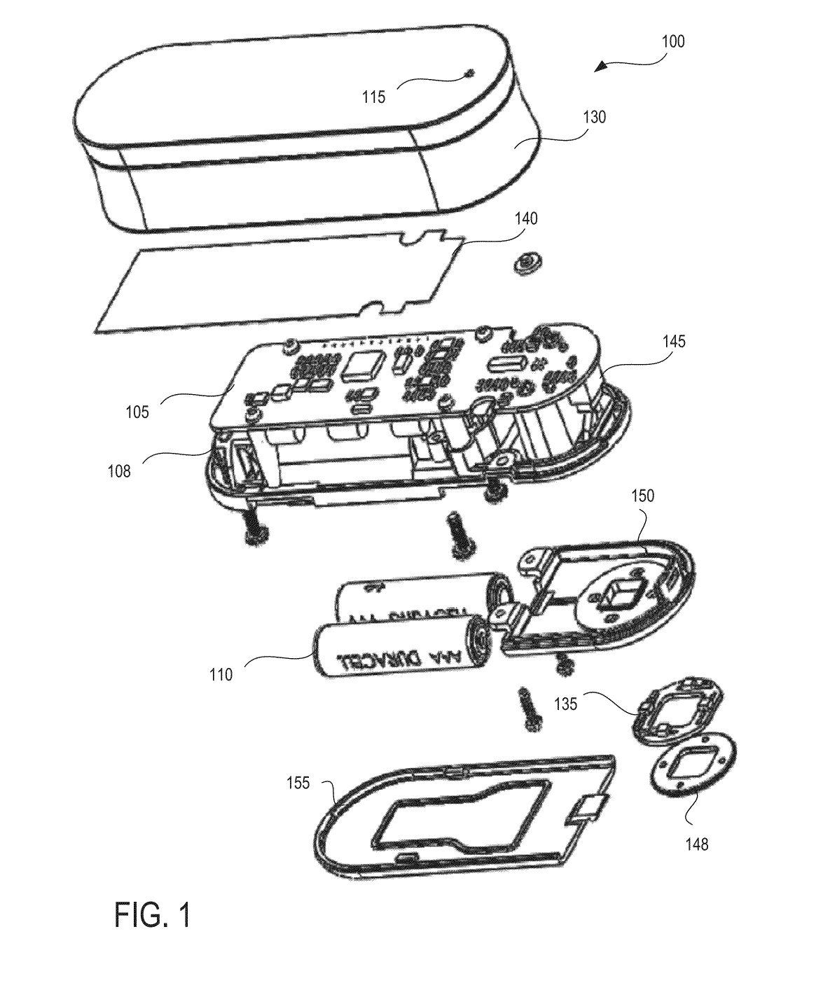

FIG. 1 is an exploded view of an electronic thermometer 100, in accordance with one embodiment. The electronic thermometer 100 includes a housing 130 (also referred to as a body), multiple internal components that are housed within the housing 130, a front cover 150 that mounts to one side of the housing 130, and a removable battery cover 155 that together with the front cover 150 encloses the internal components within the housing 130. The housing has a length, a width and a height, the length being greater than the width and the height. The housing 130, battery cover 155 and front cover 150 may be stainless steel, aluminum, graphite, plastic, or a combination thereof. Other materials may also be used for these components.

The inner components may include a printed circuit board (PCB) 105 and a thermopile 145 mounted to a chassis 108. The inner components may additionally include one or more batteries 110. The batteries 110 may be AAA batteries as shown, or may be other types of batteries. The batteries 110 may be standard batteries or rechargeable batteries.

The printed circuit board (PCB) 105 may be mounted to the chassis 108. The PCB 105 may include a wireless module and one or more additional electronic components. The wireless module may be an integrated circuit (IC) configured to manage security, manage sessions, manage communications with external devices, and so forth.

In one embodiment, the wireless module is configured to communicate using Bluetooth. Alternatively, the wireless module may be configured to communicate using Wi-Fi, Zigbee, Internet Protocol version 6 over Low power Wireless Area Networks (6LowPAN), power line communication (PLC), Ethernet (e.g., 10 Megabyte (Mb), 100 Mb and/or 1 Gigabyte (Gb) Ethernet) or other communication protocols. The wireless module may include a processing device, a memory and/or a network adapter. The processing device of the wireless module may be a microcontroller, a digital signal processor (DSP), a programmable logic controller (PLC), a microprocessor or programmable logic device such as a field programmable gate array (FPGA) or a complex programmable logic device (CPLD). The memory of the wireless module may include a non-volatile memory (e.g., RAM) and/or a volatile memory (e.g., ROM, Flash, etc.). In one embodiment, the wireless module is a system on a chip (SoC) that includes the processing device, memory and/or network adapter. In one embodiment, the memory is integrated into the processing device of the wireless module. The memory may store a common identifier that is common to some or all electronic thermometers manufactured by a particular manufacturer. The memory may additionally store a unique identifier (e.g., a serial number) that uniquely identifies a particular electronic thermometer. The memory may additionally store firmware for operating the electronic thermometer.

In one embodiment, the one or more additional electronic components may include a host processing device and/or a host memory that may be connected to the wireless module. The host processing device may be a microcontroller, a digital signal processor (DSP), a programmable logic controller (PLC), a microprocessor or programmable logic device such as a field programmable gate array (FPGA) or a complex programmable logic device (CPLD). The host memory may include a non-volatile and/or a volatile memory, and may store firmware for operating the electronic thermometer. The host processing device and/or host memory may be components of a SoC. The SoC may include the wireless module, or may be separate from the wireless module. Alternatively, the host processing device may be omitted, and the processing device of the wireless module may be relied upon to operate the electronic thermometer.

In one embodiment, a PCB insulation film 140 covers the PCB 105 to prevent unwanted electrical contact between electrical components. In one embodiment, the PCB insulation film is polyimide.

The thermopile 145 may be mounted to the PCB 105, and may be coupled to the wireless module. The thermopile 145 is an electronic device that converts thermal energy into electrical energy. The thermopile 145 may include an infrared sensor that detects thermal energy of a nearby object (e.g., of a patient). The infrared sensor may detect thermal energy of an object without actually contacting that object. The thermopile 145 converts the thermal energy detected by the infrared sensor into an electrical signal (e.g., a digital or analog signal), which is then transmitted to the wireless module. In one embodiment, the thermopile 145 generates an analog signal, and the additional components of the PCB include an analog to digital converter. The analog to digital converter may receive the analog signal, convert the analog signal to a digital signal, and provide the digital signal to the wireless module.

The electronic thermometer 100 may additionally include a target PCB assembly 135 that includes multiple guide lights. The guide lights may be light emitting diodes (LEDs) that are configured to emit point sources of light. In one embodiment, the guide lights are approximately equidistant from the infrared sensor of the thermopile. The target PCB assembly 135 in one embodiment includes a minimum of two guide lights. In one embodiment, the target PCB assembly 135 includes four or more guide lights. The infrared sensor of the thermopile 145 may be disposed between the at least two guide lights. Each of the guide lights is configured to illuminate a point on a surface to be measured, and may act in a similar manner to cross hairs to help guide a user in positioning the electronic thermometer 100 for measurement of a patient. The infrared sensor of the thermopile 145 may detect thermal infrared radiation from a point between the points illuminated by the guide lights. The PCB 105 may be electrically coupled to the target PCB assembly 135, and the wireless module or host processing device may electrically turn on and off the guide lights (e.g., responsive to instructions received from a remote user device). In one embodiment, the target PCB assembly 135 mounts to the front cover 150, and a front fascia 148 is disposed over the target PCB assembly 135. The front fascia 148 may include a large center hole through which the infrared sensor may take measurements and multiple smaller holes that are lined up with the guide lights of the target PCB assembly 135. The PCB assembly and front fascia may be disposed at a front of the electronic thermometer near one end of the electronic thermometer, as shown. Both the front fascia and the target PCB assembly may include a window or opening through which the infrared sensor receives infrared radiation. The window may be, for example, a glass window, a plastic window, or other transparent material.

In one embodiment, the housing 130 includes a light (e.g., an LED) 115. The wireless module or host processing device may turn on the light 115 to show that the electronic thermometer is turned on and/or is not in a low power state (e.g., a sleep state). The wireless module or host processing device may turn off the light 115 to show that the electronic thermometer 100 is turned off or is in a low power state. In one embodiment, the wireless module or host processing device causes the light 115 to blink (turn on and off according to a predetermined pattern) while measurements are being taken.

The wireless module may manage a power state of itself and of the rest of the electronic thermometer 100. In one embodiment, the wireless module determines when to power on and off the light 115, the guide lights of the target PCB assembly 135 and the thermopile 145, and activates and deactivates these components accordingly. In one embodiment, the wireless module maintains the components of the electronic thermometer 100 in an off state. The components that are turned off may include, for example, sensors and peripherals such as an analog to digital converter, one or more buses such as an inter-integrated circuit (I²C) bus and/or serial peripheral interface (SPI) bus, and so on. The wireless module may maintain a low power state, in which the wireless module periodically transmits a wireless signal and/or periodically listens for a wireless signal while the sensors and peripherals are turned off. When the wireless module receives a wireless signal from a user device that has a thermometer application installed thereon, the wireless module may transition out of a low power state, establish a wireless connection to that user device, and activate light 115. Once the wireless connection is established, the wireless module may wait for a command to activate the guide lights of the target PCB assembly 135 and/or for a command to activate the thermopile 145 and take measurements. Once the thermopile 145 is activated, it takes measurements which are then transmitted by the wireless module to the user device. In one embodiment, after the measurements are taken the wireless module deactivates the thermopile 145 and/or the guide lights. If no command is received from the user device for a threshold amount of time (e.g., 1 second, 3 seconds, 5 seconds, 10 seconds, 1 minute, 3 minutes, etc.), or if a deactivation command is received (e.g., from the thermometer application), the wireless module transitions to a low power state and turns off the rest of the electronic thermometer 100.

In one embodiment, the electronic thermometer 100 includes an accelerometer or other motion sensor. In such an embodiment, the wireless module may completely power off, and the accelerometer may be placed into a fully powered or low power state while the remainder of the electronic thermometer is turned off. While in the fully powered or low power state, the accelerometer may continue to detect motion. Responsive to detecting motion that exceeds a threshold, the accelerometer may cause the wireless module to transition to a fully powered or low power state. The wireless module may then listen for signals and/or send signals to connect to a user device. If no signals are received from a user device for a threshold amount of time, the wireless module may again be turned off.

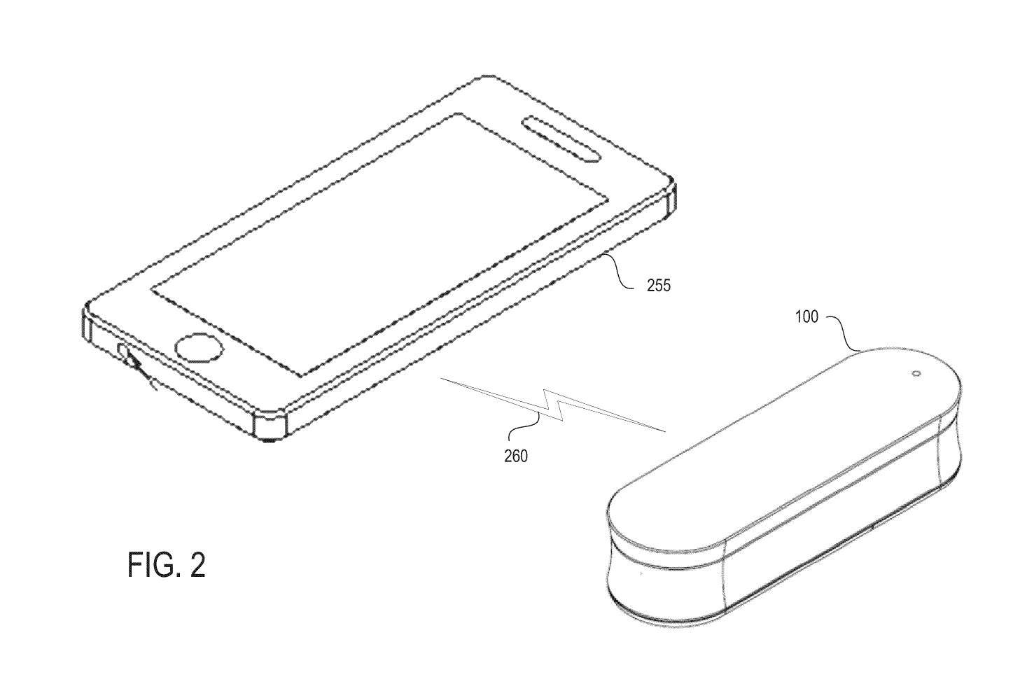

FIG. 2 is a perspective view of the electronic thermometer 100 of FIG. 1 that is connected to a user device 255 via a wireless connection 260. The user device may be a mobile computing device such as a mobile phone (as shown), or another type of mobile or traditionally non-mobile computing device such as a tablet computer, a laptop computer, a desktop computer, and so on. The user device 255 may execute a thermometer application that causes the user device 255 to send commands to the electronic thermometer 100 and receive temperature measurements from the electronic thermometer 100.

In one embodiment, the electronic thermometer 100 is a buttonless thermometer. Instead of the electronic thermometer 100 turning on or off, taking measurements, etc. responsive to button presses of buttons on the electronic thermometer, the electronic thermometer 100 may perform such actions responsive to instructions received over the wireless connection 260. For example, electronic thermometer 100 may start in a low power state in which a wireless module in the electronic thermometer 100 listens for a wireless signal or periodically transmits a wireless signal. Responsive to receiving a wireless signal from a thermometer application executing on user device 255, electronic thermometer 100 may transfer out of the low power state. A user may then cause the thermometer application to send a command to take a temperature measurement to the electronic thermometer. The command may cause the electronic thermometer 100 to take the temperature measurement.

In one embodiment, the electronic thermometer lacks a display (e.g., lacks an alphanumeric display capable of displaying temperature measurements). Accordingly, rather than displaying a value of the temperature measurement on a display of the electronic thermometer, the electronic thermometer 100 may transmit the value of the temperature measurement to the user device 255 for display thereon. By not including buttons or other movable components on the electronic thermometer 100, possible points of mechanical failure of the electronic thermometer 100 may be removed, thus potentially increasing a life span of the electronic thermometer 100. In alternative embodiments, the electronic thermometer 100 may include one or more buttons or switches (e.g., an on/off button or switch) and/or a display (e.g., an alphanumeric display).

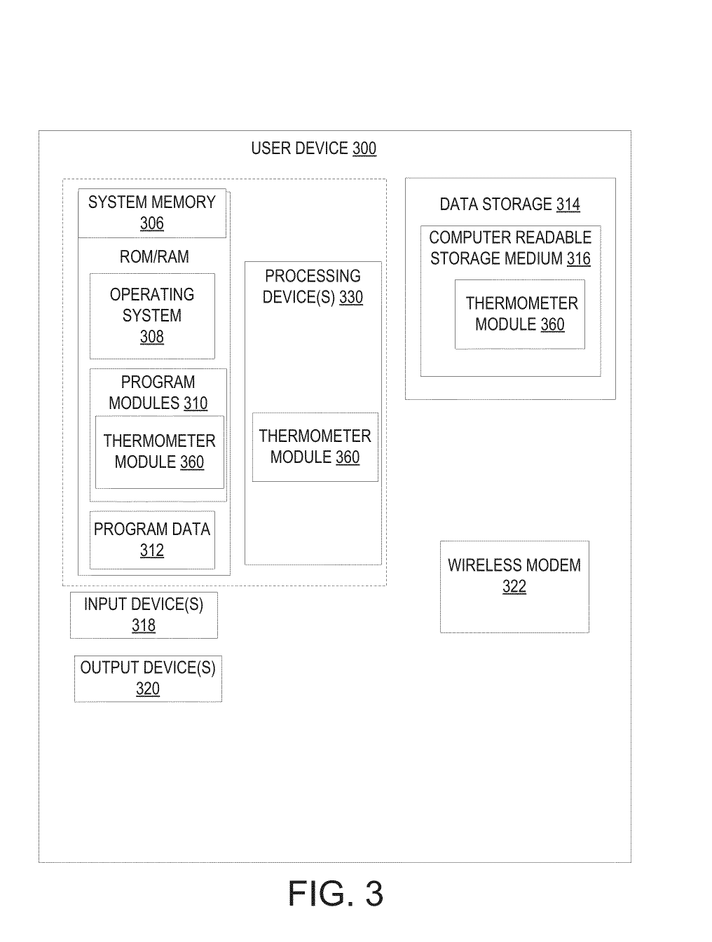

FIG. 3 is a block diagram illustrating an exemplary user device 300 that includes a thermometer module 360 installed thereon. The user device 300 may be any type of computing device such as an electronic book reader, a personal digital assistant (PDA), a mobile phone, a laptop computer, a portable media player, a tablet computer, a camera, a video camera, a netbook, a desktop computer, a gaming console, and the like. In one embodiment, the user device 300 corresponds to mobile phone 255 of FIG. 2.

The user device 300 includes one or more processing devices 330, such as one or more central processing units (CPUs), microcontrollers, field programmable gate arrays (FPGAs), digital signal processors (DSPs), and/or other types of processors. The user device 300 also includes system memory 306, which may correspond to any combination of volatile and/or non-volatile storage mechanisms. The system memory 306 stores information which provides an operating system component 308, various program modules 310 such as thermometer module 360, program data 312, and/or other components. The user device 300 performs functions by using the processing device(s) 330 to execute instructions provided by the system memory 306.

The user device 300 also includes a data storage device 314 that may be composed of one or more types of removable storage and/or one or more types of non-removable storage. The data storage device 314 includes a non-transitory computer-readable storage medium 316 on which is stored one or more sets of instructions embodying any one or more of the methodologies or functions described herein. As shown, instructions for the thermometer module 360 may reside, completely or at least partially, within the computer readable storage medium 316, system memory 306 and/or within the processing device(s) 330 during execution thereof by the user device 300, the system memory 306 and the processing device(s) 330 also constituting computer-readable media. The user device 300 may also include one or more input devices 318 (keyboard, mouse device, touchpad, touchscreen, specialized selection keys, etc.) and one or more output devices 320 (displays, printers, audio output mechanisms, tactile feedback mechanisms (e.g., vibrators) etc.).

The user device 300 may further include a wireless modem 322 to allow the user device 300 to communicate via a wireless network (e.g., such as a Wi-Fi network or a wireless network provided by a wireless carrier) with other computing devices, such as remote computers, a cloud-based medical diagnostic service, and so forth. The wireless modem 322 may allow the user device 300 to handle both voice and non-voice communications (such as communications for text messages, multimedia messages, media downloads, web browsing, etc.). Wireless modem 322 may be configured to communicate using wireless communication standards and protocols such as Wi-Fi, global system for mobile communications (GSM), code division multiple access (CDMA), wideband code division multiple access (WCDMA), time division multiple access (TDMA), universal mobile telecommunications system (UMTS), long term evolution (LTE), worldwide interoperability for microwave access (WiMAX), and so on.

Thermometer module 360 may be an application “app” programmed to execute on the iOS® operating system, the Android® operating system, the Windows® operating system, or another operating system. The thermometer module 360 may communicate with one or more electronic thermometers to cause the electronic thermometers to transition into or out of a low power state, to cause the electronic thermometers to activate guide lights, to cause the electronic thermometers to generate temperature measurements and report those temperature measurements to the thermometer module 360, and so on. Thermometer module 360 may additionally store a record of temperature measurements, and may report temperature measurements to additional computing devices, such as to a server computing device.

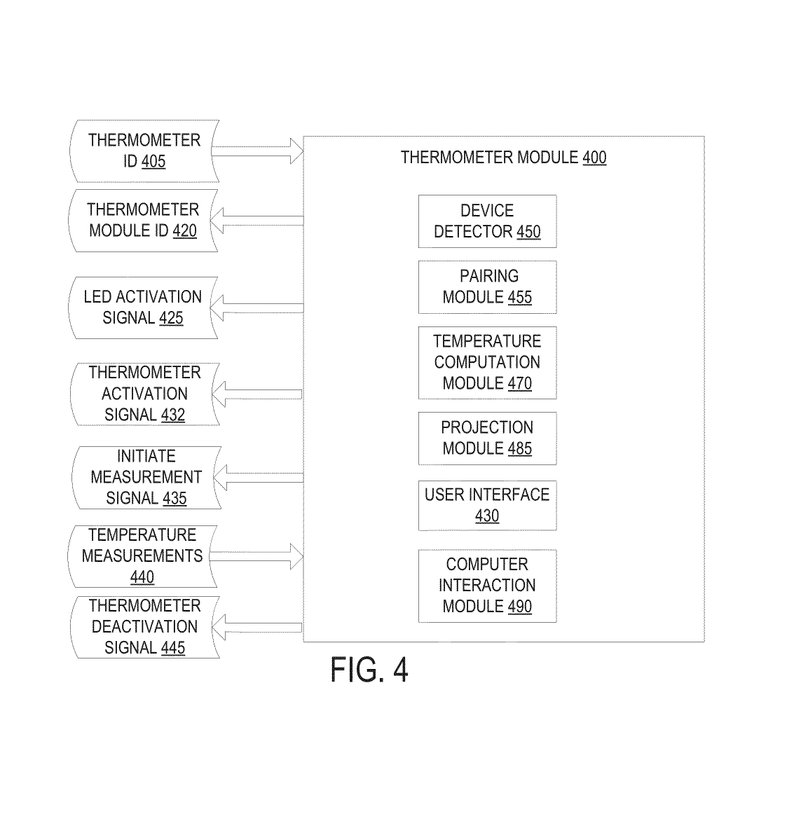

FIG. 4 is a block diagram of one embodiment of a thermometer module 400, which may correspond to the thermometer module 360 of FIG. 3. The thermometer module 400 may be implemented in software, firmware, hardware, or a combination thereof. In one embodiment, the thermometer module 400 includes a user interface 430, a device detector 450, a pairing module 455, a temperature computation module 470 and a computer interaction module 490. The functionality of one of more of these components may also be combined into a single module or divided into multiple modules.

Device detector 450 may detect when a user device on which thermometer module 400 runs is within an RF transmission range of an electronic thermometer, such as electronic thermometer 100 of FIGS. 1-2. In one embodiment, the transmission range is 10 meters. In another embodiment, the transmission range is 5 meters. In one embodiment, the line of sight transmission range is 15 meters, and the radio frequency (RF) power at 15 meters is −70 dBm. Other transmission ranges may also be used. Lower transmission ranges has a lower power consumption, and thus increase battery life. The Electronic thermometer may periodically transmit RF signals (e.g., in accordance with the Bluetooth protocol). These signals may identify a thermometer identifier (ID) 405 of the electronic thermometer. The thermometer ID 405 may include a common ID that is shared by multiple electronic thermometers and/or a unique ID that is assigned to a specific electronic thermometer. Device detector 450 may also transmit a thermometer module ID 420 of the thermometer module 400. The thermometer module ID 420 may include a common ID that is common to all thermometer modules and/or a unique ID that is unique to a particular installation of the thermometer module 400.

Responsive to device detector 450 detecting the electronic thermometer and receiving a thermometer ID, device detector 450 may compare the thermometer ID to an authorization criterion to determine whether to establish a connection with the electronic thermometer. In one embodiment, device detector 450 determines whether the thermometer ID is a valid thermometer ID and/or whether the thermometer ID matches a stored thermometer ID (e.g., in a list of valid thermometer IDs). Once the electronic thermometer is authenticated, pairing module 455 may send a thermometer activation signal 432 to the electronic thermometer and/or establish a wireless connection with the electronic thermometer to pair the user device on which the thermometer module 400 executes to the electronic thermometer. Alternatively, no authentication of the electronic thermometer may be performed in some embodiments.

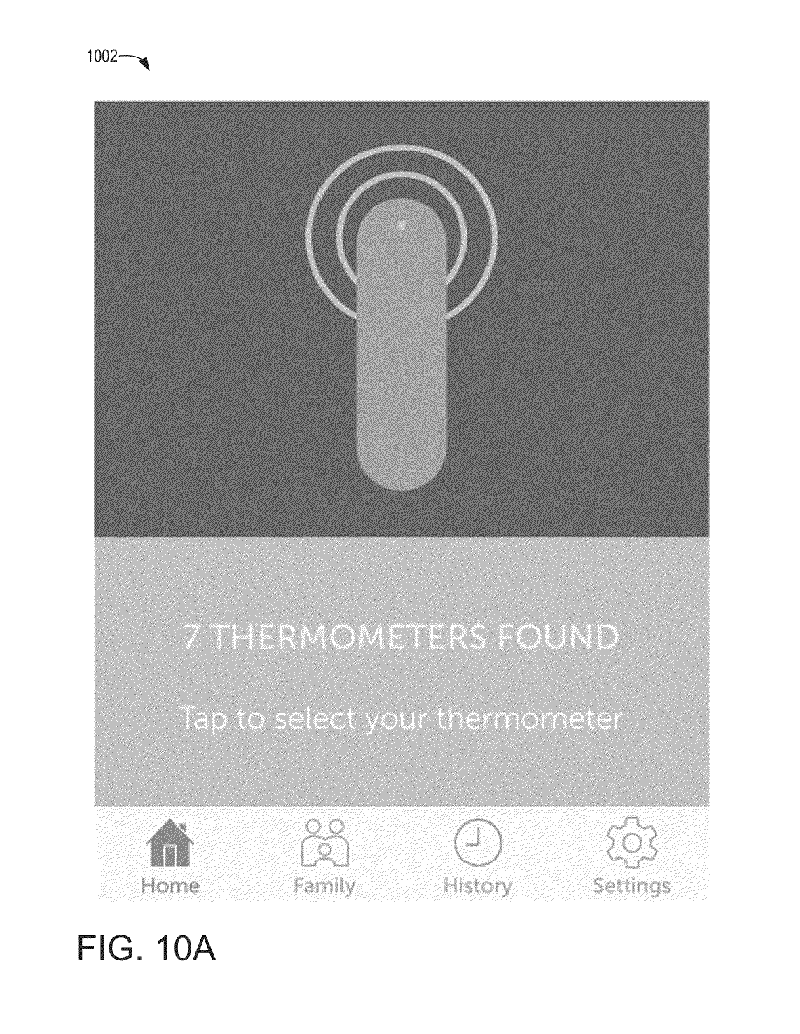

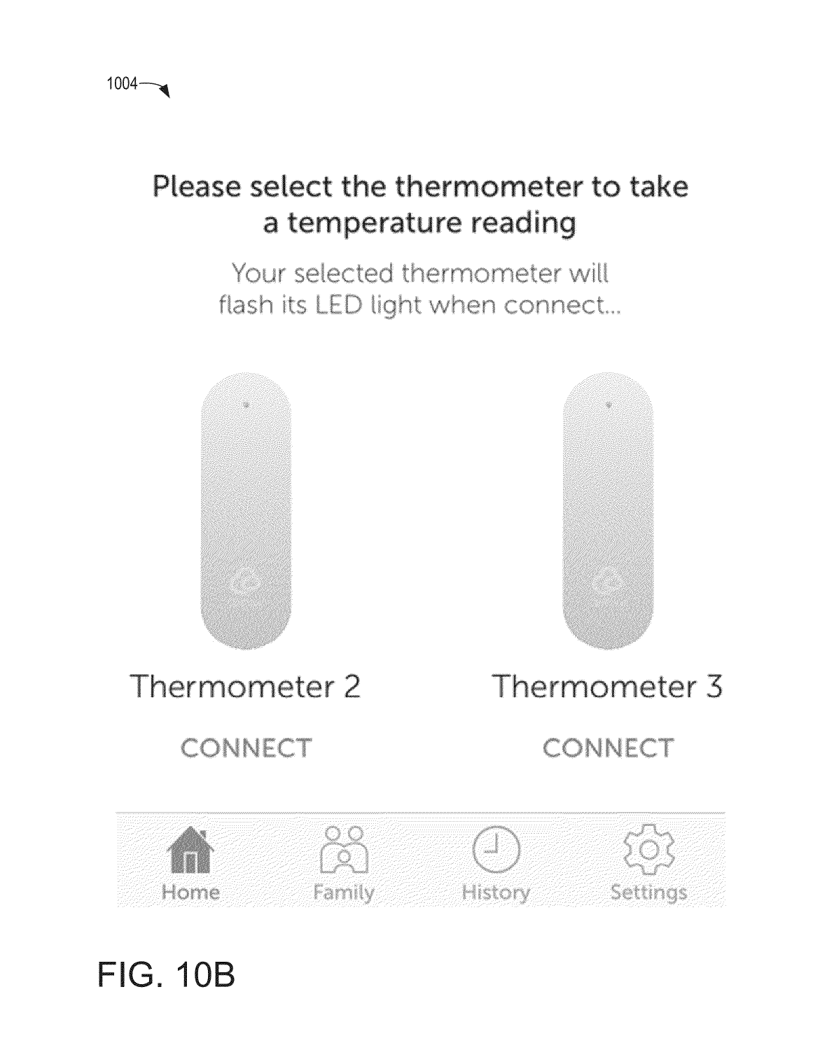

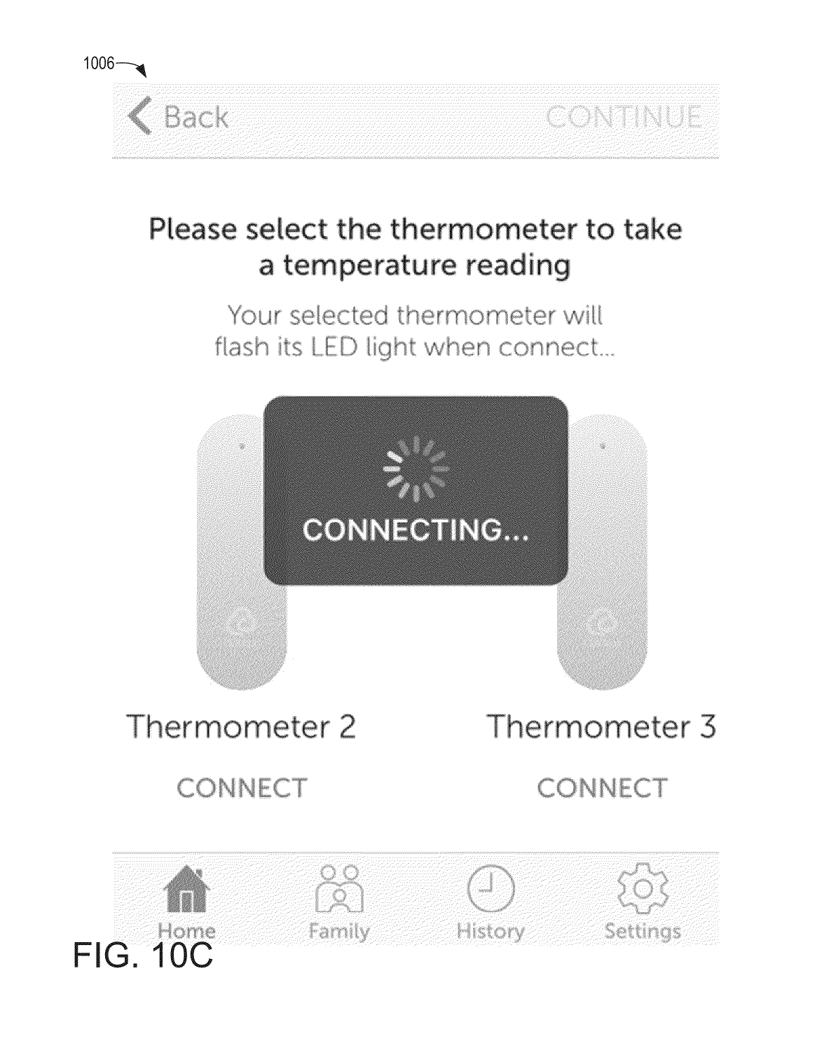

In some instances, device detector 450 may detect multiple different electronic thermometers. In such an instance, a user may be prompted via the user interface 430 to select one of the available electronic thermometers to pair to. The user interface 430 may provide a list of the available electronic thermometers. A user may then select one of the available electronic thermometers for use. Responsive to the user interface receiving a user indication (e.g., an initial selection) of a particular electronic thermometer, pairing module 455 may send a light activation signal 425 to that electronic thermometer to cause that electronic thermometer to activate one or more LEDs or other lights. Responsive to the user interface receiving a user indication (e.g., an initial selection) of another electronic thermometer, pairing module 455 may send a light activation signal 425 to that other electronic thermometer to cause that electronic thermometer to activate one or more LEDs or other lights. This enables the user to see which electronic thermometer corresponds to each representation of an electronic thermometer in the thermometer module 400. FIGS. 10A-D show the selection process when multiple electronic thermometers are detected.

Referring back to FIG. 4, once thermometer module 400 is paired to an electronic thermometer, user interface 430 may guide a user through the taking of a patient's or other individual's temperature. The user may then press a “take measurement” button provided by the user interface 430, which may cause thermometer module 400 to send an initiate measurement signal 435 to the electronic thermometer. The user device on which the thermometer module 400 runs may then receive one or more temperature measurements 440 from the electronic thermometer.

Temperature computation module 470 processes the temperature measurements to determine a temperature of a patient. Thermometer module 400 may receive multiple temperature measurements (e.g., 3 measurements, 5 measurements, 10 measurements, 14 measurements, and so on). Temperature computation module 470 may then average the multiple measurements to determine the patient temperature. Alternatively, or additionally, temperature computation module 470 may determine a median temperature, a maximum temperature, a minimum temperature, one or more quartile temperature, and/or other statistical value of the temperature. In one embodiment, temperature computation module 470 additionally determines a delta or standard deviation between the multiple temperature measurements. If the delta or standard deviation is greater than a threshold (e.g., if the delta is greater than 1 degree Celsius or Fahrenheit), this may indicate a low confidence in the temperature measurement. Accordingly, if the delta or standard deviation is greater than the threshold, a user interface 430 may prompt a user to take an additional measurement.

In one embodiment, temperature computation module 470 determines a geographic location of the user device on which it executes and/or a language setting of the user device. The language setting may be, for example, US English, United Kingdom English, Japanese, and so forth. The geographic location may be determined using a global positioning system (GPS) receiver of the user device, based on triangulation with multiple cell towers of a wireless carrier, and/or based on a home location setting of the user device. Different countries use different temperature standards. For example, the United States uses Fahrenheit units to measure temperature, and most other countries use Celsius units to measure temperature. Based on the language setting and/or the geographic location of the user device, temperature computation module 470 may determine which units to use for the temperature measurement. Temperature computation module 470 may then convert the determined temperature from an initial unit of measurement to the unit of measurement used at the current geographic location or for the language setting if they are not the same. For example, temperature measurements 440 may be created in Celsius, and if the user device is in the United States then temperature computation module 470 may convert the temperature measurements (or the final determined temperature) from Celsius to Fahrenheit.

User interface 430 may be a graphical user interface that may output instructions to take measurements (e.g., graphically display where to place the thermometer) as well as a final measured temperature. The user interface 430 may also generate an audio output (e.g., a beep or other noise) based on an outcome of the temperature. For example, if the temperature exceeds 98.6 for an adult, then the user interface 430 may generate an audio alarm. In embodiments, thermometer module 400 executes on a user device that includes a touch screen (e.g., on a mobile phone or tablet computer). In such an embodiment, user interface 430 may generate graphical icons of buttons that a user may press on the touch screen to perform operations. For example, the user interface 430 may generate a button that, when pressed, causes a command to take a measurement to be sent to the electronic thermometer.

In one embodiment, the thermometer module 400 includes a projection module 485 that establishes a connection to an additional device. The additional device may be a tablet computer, television (e.g., smart television), desktop computer, laptop computer, mobile phone, wearable computer (e.g., Google Glass®, smart watch, etc.), and so on. The connection may be established via Bluetooth, Zigbee, Wi-Fi, or other wireless communication protocol. In one embodiment, the projection module 485 creates a socket server that connects via Wi-Fi to the additional computing device.

Projection module 485 may then transmit temperature measurements to the additional device for display thereon. Alternatively, projection module 485 may generate an image (e.g., a graphics interchange format (GIF), joint photographic experts group (JPEG), portable network graphics (PNG), tagged image file format (TIFF), or other image file) or a video (e.g., a moving picture experts group (MPEG), audio video interleave (AVI), Flash video (FLV), Quicktime file format (MOV), Windows media video (WMV), or other video file), that shows the measured temperature value. Projection module may then send the image or video to the additional device for display thereon. In one embodiment, projection module 485 streams a series of images or frames of a video to the additional device.

In an example of a hospital environment, the projection module 485 may establish a connection to a display in a hospital room, and may cause the temperature measurement to be output on the display. This may cause the temperature measurement to be prominently displayed so that a patient and all medical staff can easily see it.

In one embodiment, thermometer module 400 includes a computer interaction module 490. Computer interaction module 490 may establish a connection to a computing device that hosts a medical data storage service or application and/or other medical service or application. The computing device may be a desktop computer, laptop computer, blade server, rackmount server, and so on. Server interaction module 490 may send the temperature measurement to the computing device along with additional information such as patient name, a unique patient identifier, a thermometer ID of an electronic thermometer that generated the temperature measurement, a date and time, patient symptoms, and/or other data. The computing device may then store the temperature measurement and/or additional information.

In one embodiment, thermometer module 400 sends a thermometer deactivation signal 445 after a temperature is taken. Alternatively, or in addition, the electronic thermometer may automatically shut off or transition to a low power state without receiving any deactivation signal from thermometer module 400.

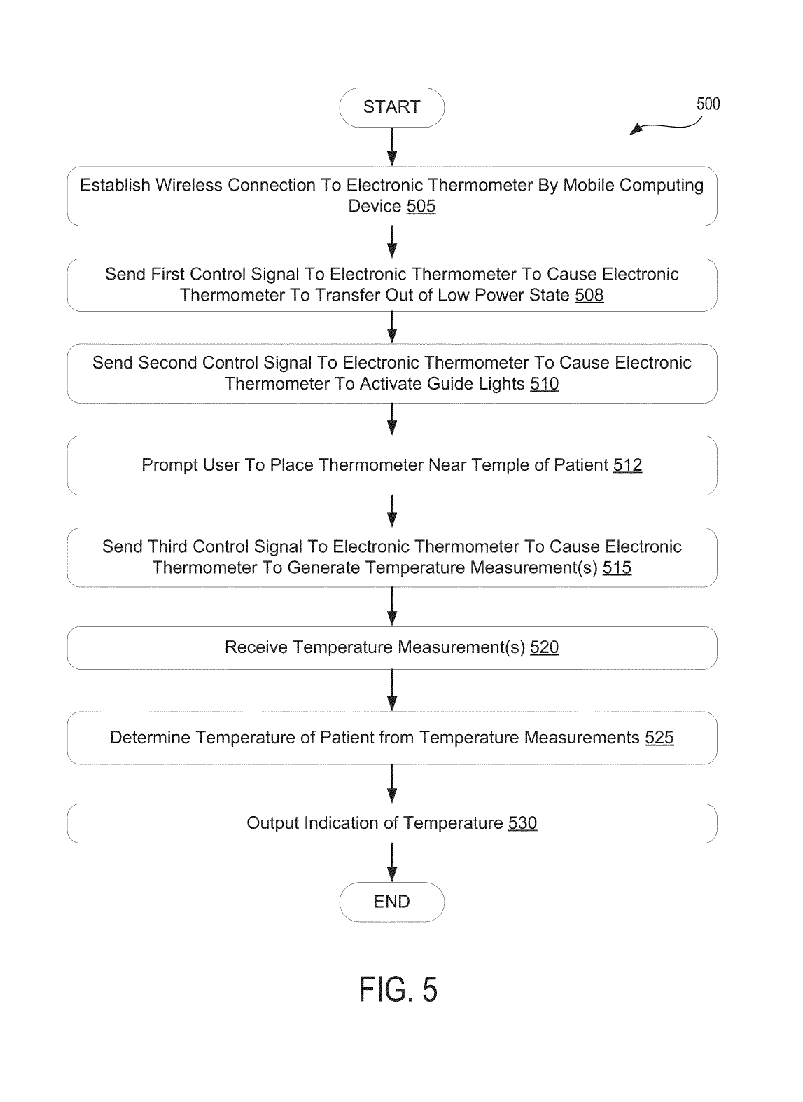

FIGS. 5-7 are flow diagrams illustrating methods of interfacing with an electronic thermometer and of determining a patient's temperature based on measurements received from the electronic thermometer. These methods may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. The methods may be performed by a user device, such as user device 300 of FIG. 3.

For simplicity of explanation, the methods are depicted and described as a series of acts. However, acts in accordance with this disclosure can occur in various orders and/or concurrently and with other acts not presented and described herein. Furthermore, not all illustrated acts may be performed to implement the methods in accordance with the disclosed subject matter. In addition, those skilled in the art will understand and appreciate that the methods could alternatively be represented as a series of interrelated states via a state diagram or events.

FIG. 5 is a flow diagram illustrating one embodiment for a method 500 of controlling an electronic thermometer (e.g., an electronic infrared thermometer) by a user device executing a thermometer module. At block 505 of method 500, processing logic of a user device (e.g., a mobile computing device) establishes a wireless connection to an electronic thermometer. At block 508, processing logic sends a first control signal to the electronic thermometer to cause the electronic thermometer to transfer out of a low power state. Alternatively, the electronic thermometer may automatically transfer out of the low power state responsive to detecting a signal from the user device. In another embodiment, the electronic thermometer may include an accelerometer, and may transition out of the low power state responsive to detecting any accelerations or responsive to receiving accelerations (e.g., linear and/or rotational accelerations) that exceed an acceleration threshold.

At block 510, processing logic sends a second control signal to the electronic thermometer to cause the electronic thermometer to activate one or more guide lights. At block 512, processing logic may prompt a user to place the electronic thermometer near a temple of a patient (e.g., within 1 inch of a patient's temple). At block 515, processing logic may then send a third control signal to cause the electronic thermometer to generate one or more temperature measurements. In one embodiment, processing logic receives a user command to generate the one or more measurements (e.g., based on a user pressing a button on the user device), and subsequently sends the third control signal responsive to the user command.

At block 520, processing logic receives the one or more temperature measurements. At block 525, processing logic determines a temperature of a patient from the temperature measurements. In one embodiment, multiple temperature measurements are received, and processing logic determines an average or other statistical value of the multiple measurements. In one embodiment, processing logic additionally compares the multiple measurements to determine a standard deviation and/or a temperature delta between a highest temperature value and a lowest temperature value. If the temperature delta or standard deviation exceeds a threshold, then processing logic may return an error. In one embodiment, processing logic determines a unit of measurement for the temperature and outputs the temperature using the determined unit of measurement. This may include performing a units conversion. At block 530, processing logic then outputs an indication of the determined temperature (e.g., displays the temperature in a user interface). The method then ends.

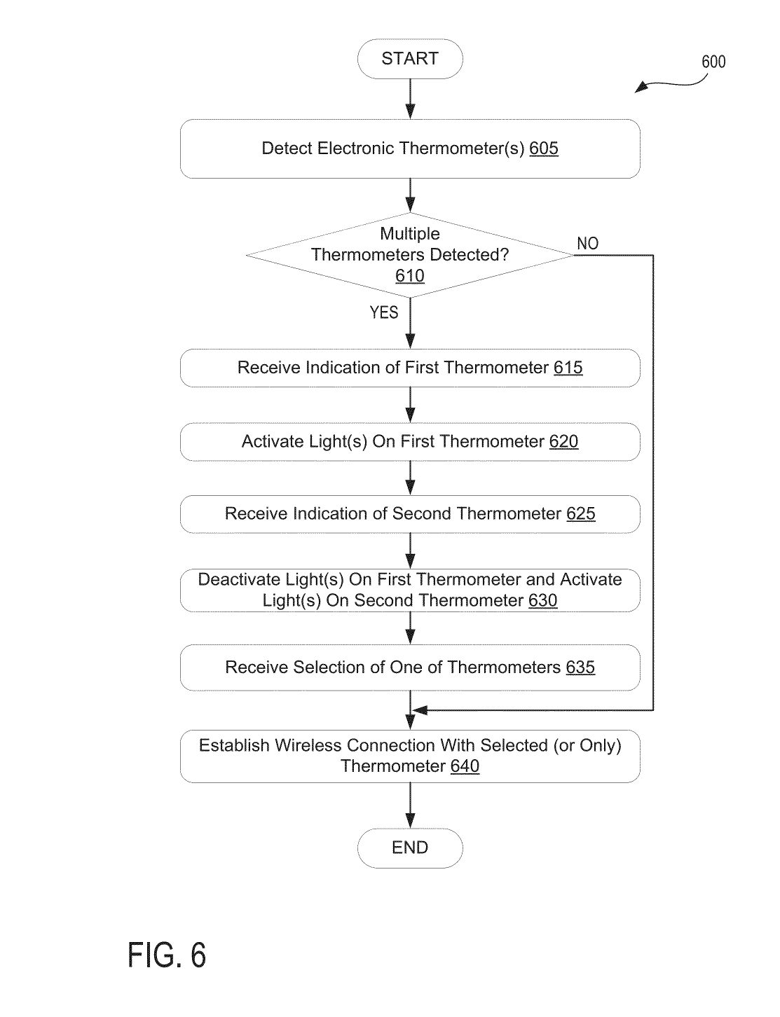

FIG. 6 is a flow diagram illustrating one embodiment for a method 600 of establishing a wireless connection between a user device executing a thermometer module and an electronic thermometer. At block 605 of method 600, processing logic detects one or more electronic thermometers. At block 610, processing logic determines whether multiple thermometers have been detected. If only a single thermometer is detected, the method proceeds to block 640. If multiple thermometers are detected, the method continues to block 615. In one embodiment, if multiple thermometers are detected, processing logic notifies a user that multiple thermometers have been detected, and prompts a user to select a thermometer. FIG. 10A illustrates one example display 1002 notifying a user of multiple detected thermometers. FIG. 10B illustrates another example display 1004 that prompts a user to select an available thermometer.

Referring back to FIG. 6, at block 615, processing logic receives an indication of a first thermometer. For example, a user may highlight or scroll to the first thermometer in a list of thermometers that may be displayed in a user interface of the thermometer module (e.g., as shown in FIG. 10B). At block 620, processing logic sends a control signal to the first thermometer to cause one or more lights (e.g., LEDs) on the first thermometer to activate. At block 625, processing logic may receive an indication of a second thermometer. For example, a user may highlight or scroll to the second thermometer in the list of thermometers that may be displayed in the user interface of the thermometer module. At block 630, processing logic sends a control signal to the first thermometer to cause the lights on the first thermometer to deactivate and sends an additional control signal to the second thermometer to cause one or more lights (e.g., LEDs) on the second thermometer to activate.

At block 635, processing logic receives a selection of one of the available thermometers (e.g., a user input to select a particular thermometer). For example, a user by click on or press on a button image associated with one of the thermometers. At block 640, processing logic establishes a wireless connection with the selected thermometer (or with the only thermometer if there was just a single thermometer). While processing logic is establishing a connection with the selected thermometer, an updated display 1006 as shown in FIG. 10C may be shown. The updated display 1006 shows that the processing logic is in the process of connecting to the selected thermometer.

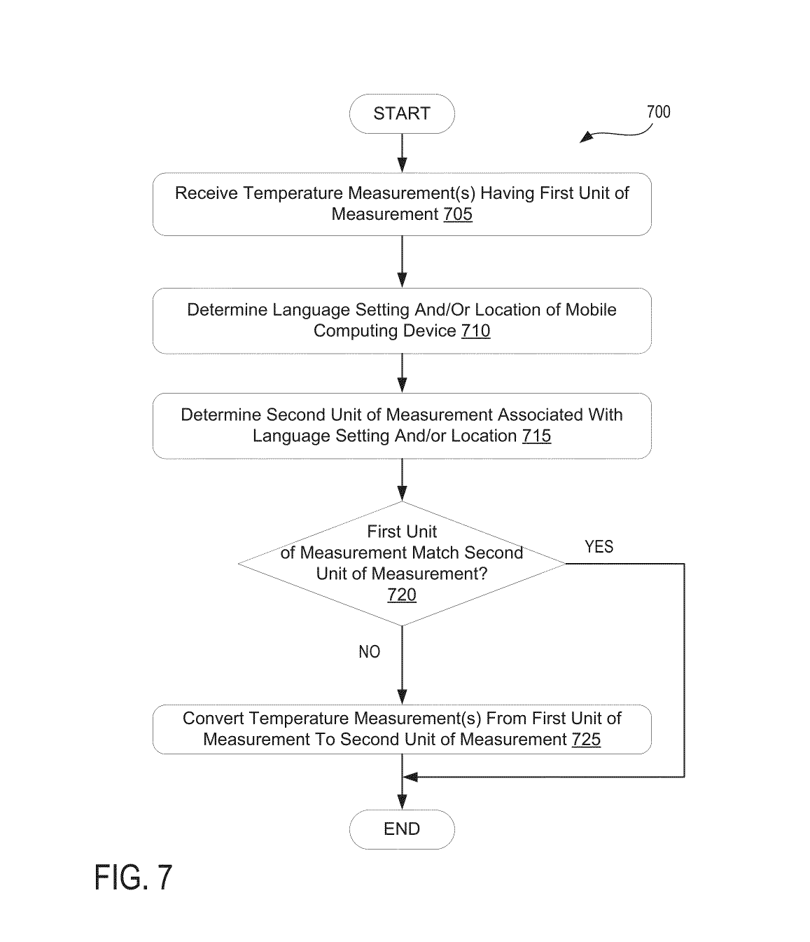

FIG. 7 is a flow diagram illustrating one embodiment for a method 700 of selecting the unit of measurement for outputting measurements of an electronic thermometer. At block 705 of method 700, processing logic receives one or more temperature measurements from an electronic thermometer, the one or more temperature measurements having a first unit of measurement. At block 710, processing logic determines a language setting and/or a location of a mobile computing device on which a thermometer module is installed. At block 715, processing logic determines a second unit of measurement associated with the language setting and/or the location.

At block 720, processing logic determines whether the first unit of measurement matches the second unit of measurement. If the units of measurement match, the method ends. If the units of measurement do not match, then the method continues to block 725, and processing logic converts the temperature measurements from the first unit of measurement to the second unit of measurement. For example, a temperature measurement may be converted from Celsius to Fahrenheit using the algorithm ° F.=° C.×9/5+32. The temperature measurements may then be displayed in the second unit of measurement.

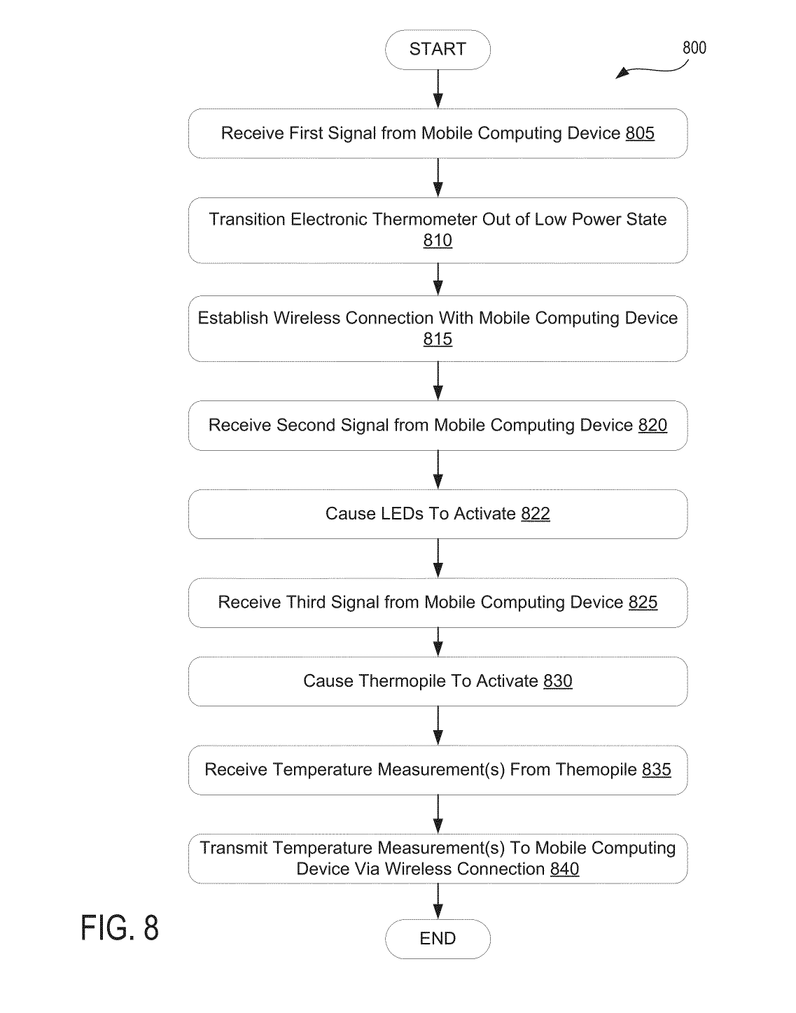

FIG. 8 is a flow diagram illustrating one embodiment for a method 800 of operating an electronic infrared thermometer. Method 800 may be performed by processing logic of an electronic thermometer that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 800 is performed by electronic thermometer 100 of FIGS. 1-2.

At block 805 of method 800, processing logic of an electronic thermometer receives a first signal from a mobile computing device. The first signal may be, for example, a device activation signal. At block 810, processing logic of the electronic thermometer transitions the electronic thermometer out of a low power state. At block 815, processing logic establishes a wireless connection to the mobile computing device.

In one embodiment, a thermometer module executing on the mobile computing device sends a thermometer module ID to the electronic infrared thermometer. Processing logic may then compare the thermometer module ID to an authentication criterion. If the thermometer module ID satisfies the authentication criterion, processing logic may establish the wireless connection.

In one embodiment, the authentication criterion is satisfied if the thermometer module ID determined to be a valid thermometer module ID. Validity can be determined using a list of valid IDs, using an ID verification algorithm, or a combination thereof. For example, the thermometer module ID may include a common ID and a unique ID. The common ID may be compared to a stored ID and the unique ID may be processed using an ID verification algorithm.

At block 820, processing logic receives a second signal from the mobile computing device. The second signal may be, for example, an LED (or other light) activation signal. At block 822, processing logic causes one or more LEDs of the electronic thermometer to activate responsive to the second signal. At block 825, processing logic receives a third signal from the mobile computing device. The third signal may be, for example, a command to generate a temperature measurement. At block 830, the processing logic causes a thermopile of the electronic thermometer to activate and begin to take temperature measurements.

At block 835, processing logic receives one or more temperature measurements from the thermopile. At block 840, processing logic transmits the one or more temperature measurements to the mobile computing device via the wireless connection. The processing logic may then deactivate the LEDs and/or other components of the electronic thermometer, and may transition the electronic thermometer back into the low power state. This may be performed automatically or responsive to an additional signal (e.g., a deactivation signal) from the mobile computing device.

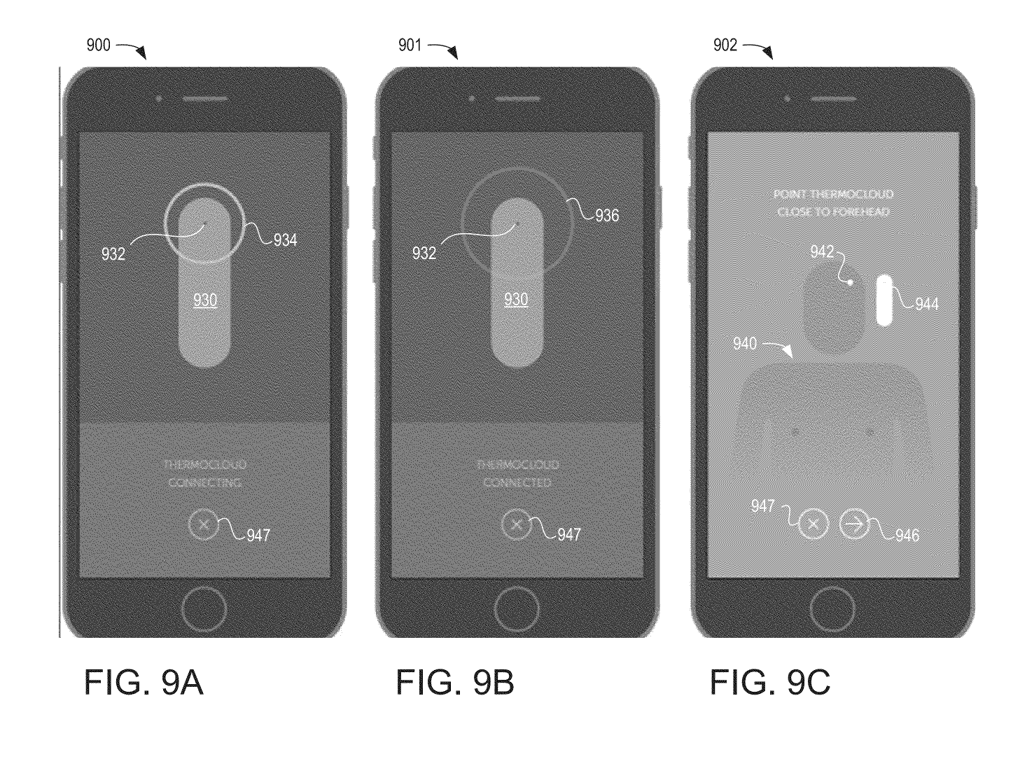

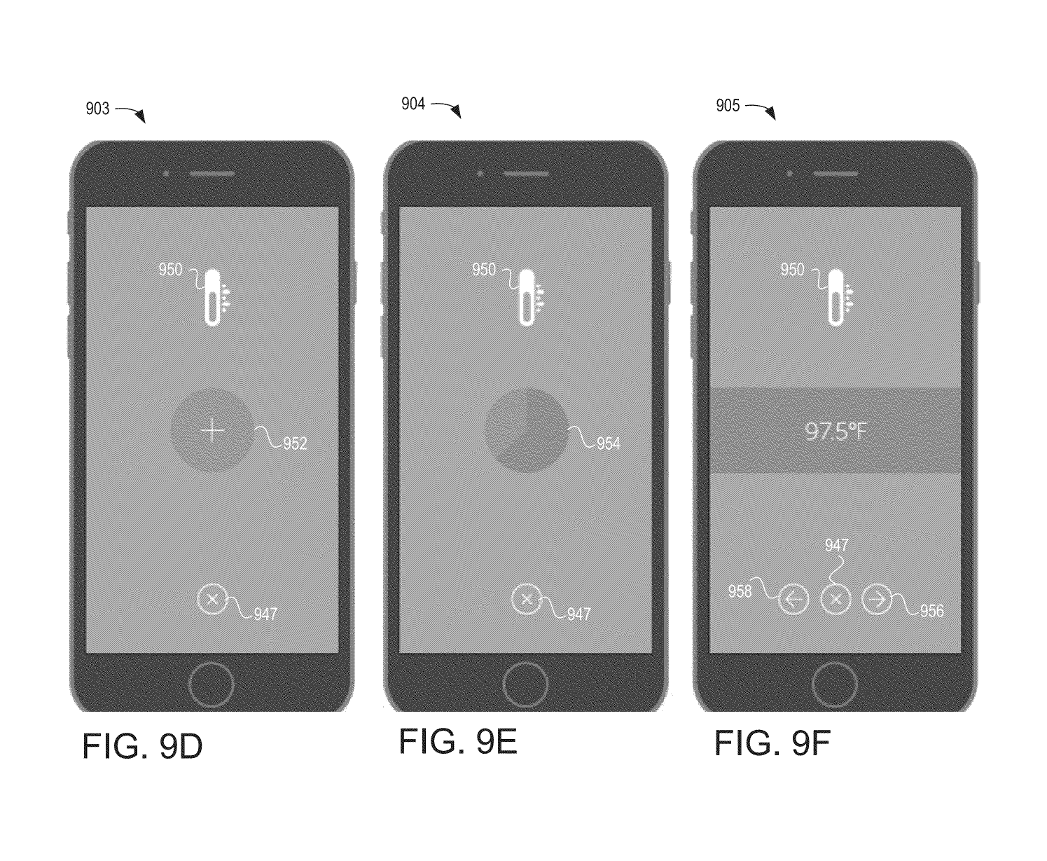

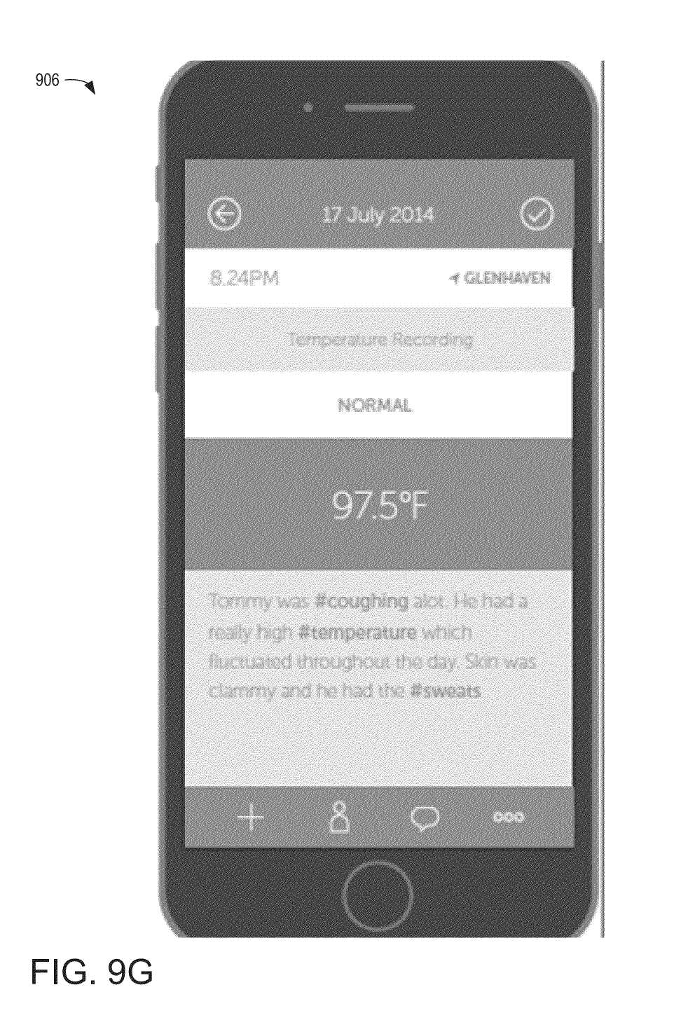

FIGS. 9A-9G are various views of a user interface of a thermometer module that executes on a user device, in accordance with one embodiment. In the illustrated example, the user device is a mobile phone. However, the user device may also be a tablet computer or any other type of user device described herein. View 900 of FIG. 9A shows the user interface before the thermometer module executing on the user device has connected to an electronic thermometer. View 900 may show an image of an electronic thermometer 930 with a deactivated light 932 that may indicate a disconnected state between the electronic thermometer and the use device. View 900 may additionally include a first circle 934 around the light 932. View 900 may also include a “connecting” message. View 901 of FIG. 9B shows the user interface after the user device has wirelessly connected to the electronic thermometer. View 901 may show an image of the electronic thermometer 930 with an activated light 932, which may indicate a connected state. View 901 may additionally include a second circle 936 around the light 932. The second circle 936 may have a larger diameter than the first circle 934 and/or may be shown in a different color than the first circle 934. View 901 may additionally include a “connected” message.

FIG. 9C shows view 902 instructing a user to point the electronic thermometer near a forehead of a person (e.g., a patient). For example, view 902 may show a stylized image of a person 940 with a small circle 942 at a forehead of the stylized image of the person 940 and an image of an electronic thermometer 944 near the small circle 942. After a user places the electronic thermometer near a person's temple, they may press a button 946 to initiate a temperature measurement. In view 902 a right arrow button is used to initiate a temperature measurement. However, other button images may also be used. In each of views 900-902, a cancel button 947 may be pressed at any time to cancel a temperature measurement.

FIGS. 9D-9E show views 903, 904 of the user interface during temperature acquisition by the electronic thermometer. These views 903, 904 show a stylized image of a mercury thermometer 950. View 903 additionally shows an image of a cross hairs inside of a circle 952, which may indicate that a temperature measurement has begun. View 904 additionally shows a pie chart 954 that is updated during the temperature measuring process. In the illustrated example, the pie chart 954 shows a completed percentage of the temperature measurement in a dark color, and further shows an uncompleted percentage of the temperature measurement in a light color. As the temperature measuring process proceeds, the dark portion of the pie chart 954 may expand in a clockwise direction, and the light portion of the pie chart may contract in a corresponding manner. When the temperature measurement is complete, the pie chart 954 may briefly show a solid circle in the dark color.

FIG. 9F shows view 905 of the user interface after a temperature has been computed. As shown in view 905, the temperature may be displayed. In the shown example, a temperature of 97.5 degrees F. was measured. A user may select to take a new temperature or to save the received temperature (e.g., by pressing a right arrow button 956). The user may alternatively select to redo the temperature measurement (e.g., by pressing a left arrow button 958).

FIG. 9G shows view 906 of the user interface after a temperature has been recorded. The thermometer module may compare the received temperature to one or more temperature thresholds to determine whether the temperature is a healthy temperature. For example, the thermometer module may compare the determined temperature to an upper temperature threshold and a lower temperature threshold. In one embodiment, an upper threshold of 98.6° F. and a lower threshold of 96° F. are used. If the temperature is above the upper temperature threshold or below the lower temperature threshold, then the user interface may output a warning. For example, if the temperature is below the lower temperature threshold, the user interface may output a “temperature too low” message. If the temperature is above the upper temperature threshold, the user interface may output a “fever” message. Depending on how much the upper threshold is exceeded by, the user interface may output different messages. For example, a temperature of 104 degrees ° F. may cause the user interface to output a “severe temperature” warning along with a suggestion to seek medical assistance. In some instances the user interface may provide a button to call for medical assistance if a temperature exceeds a second upper threshold or a second lower threshold. For example, in the United States the button may dial 9-1-1 on being pressed. Alternatively, a user may configure the temperature module to provide a button to call a particular phone number (e.g., a phone number of the user's doctor) or to send a message (e.g., an email message or a text message) to the user's doctor indicating the user's identity and temperature. If the detected temperature is between the upper and lower thresholds, then the user interface may output a “normal” message.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware, or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “establishing,” “sending,” “processing,” “converting,” “receiving,” “outputting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

Use of the term “an embodiment” or “one embodiment” or “an implementation” or “one implementation” throughout this application is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

Embodiments described herein may also relate to an apparatus for performing the operations herein. This apparatus may be specially constructed for specific purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, or any other non-transitory medium that is capable of storing a set of instructions for execution by the machine and that causes the machine to perform any one or more of the methodologies of the present embodiments.

The above description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
establishing, by a mobile computing device executing a thermometer application, a wireless connection to an electronic infrared thermometer;
sending a first control signal to the electronic infrared thermometer via the wireless connection, wherein the first control signal causes the electronic infrared thermometer to activate an infrared detector to generate one or more temperature measurements;
receiving the one or more temperature measurements;
determining, by the mobile computing device, a temperature of a patient based on the one or more temperature measurements; and
outputting an indication of the temperature.

2. The method of claim 1, wherein the wireless connection is a Bluetooth connection.

3. The method of claim 1, wherein establishing the wireless connection to the electronic infrared thermometer comprises:
detecting a first electronic infrared thermometer having a common identifier that identifies the first electronic infrared thermometer as an electronic infrared thermometer and a first unique identifier;
detecting a second electronic infrared thermometer having the common identifier and a second unique identifier;
activating one or more lights on the first electronic infrared thermometer while the first electronic infrared thermometer is indicated by the thermometer application;
activating one or more lights on the second electronic infrared thermometer while the second electronic infrared thermometer is indicated by the thermometer application;
receiving selection of the first electronic infrared thermometer or the second electronic infrared thermometer; and
establishing the wireless connection with the selected electronic infrared thermometer.

4. The method of claim 1, wherein the one or more temperature measurements comprises a plurality of digital temperature measurements, and wherein determining the temperature of the patient comprises computing a statistical value from the plurality of digital temperature measurements.

5. The method of claim 1, further comprising:
prompting a user of the electronic infrared thermometer to place the electronic infrared thermometer near a temple of the patient.

6. The method of claim 1, further comprising:
sending a second control signal to the electronic infrared thermometer prior to sending the first control signal, wherein the second control signal causes the electronic infrared thermometer to transfer out of a low power state.

7. The method of claim 1, further comprising:
sending a second control signal to the electronic infrared thermometer prior to sending the first control signal, wherein the second control signal causes the electronic infrared thermometer to activate two or more guide lights, wherein each of the two or more guide lights is to illuminate a point on the patient, and wherein the infrared detector detects thermal infrared radiation from an additional point between the points illuminated by the two or more guide lights.

8. The method of claim 1, wherein the one or more temperature measurements have a first unit of measurement, the method further comprising:
determining at least one of a language setting or a location of the mobile computing device;
determining whether a second unit of measurement associated with at least one of the language setting or the location is the same as the first unit of measurement; and
responsive to determining that the first unit of measurement is different than the second unit of measurement, converting the one or more temperature measurements from the first unit of measurement to the second unit of measurement.

9. An electronic infrared thermometer comprising:
a body;
a thermopile housed within the body, the thermopile comprising an infrared sensor; and
a wireless module, housed within the body and electrically coupled to the thermopile, the wireless module to:
receive a first signal from a mobile computing device;
transition the electronic infrared thermometer out of a low power state responsive to receipt of the first signal;
establish a wireless connection with the mobile computing device;
receive a second signal from the mobile computing device via the wireless connection; and
responsive to the second signal, perform the following comprising:
cause the thermopile to activate;
receive one or more temperature measurements from the thermopile; and
transmit the one or more temperature measurements to the mobile computing device via the wireless connection.

10. The electronic infrared thermometer of claim 9, further comprising:
at least two light emitting diodes (LEDs), wherein the infrared sensor is disposed between the at least two LEDs, wherein each of the at least two LEDs are to illuminate a point on a surface to be measured, and wherein the infrared sensor detects infrared radiation from an additional point on the surface between the points illuminated by the two or more LEDs.

11. The electronic infrared thermometer of claim 10, wherein the wireless module is further to:
receive a second signal prior to establishing the wireless connection; and
responsive to the second signal, cause the at least two LEDs to turn on.

12. The electronic infrared thermometer of claim 10, wherein the at least two LEDs comprise four LEDs that are approximately equidistant from the infrared sensor.

13. The electronic infrared thermometer of claim 9, wherein the body has a length, a height and a width, the length being greater than the height and the width, the body further having a bottom comprising the length and the width, the bottom comprising, near one end, a window through which the infrared detector receives infrared radiation.

14. The electronic infrared thermometer of claim 9, wherein the wireless module comprises a Bluetooth module.

15. The electronic infrared thermometer of claim 9, wherein the electronic infrared thermometer has no buttons.

16. A non-transitory computer readable storage medium comprising instructions that, when executed by a user device, cause the user device to perform actions comprising:
establishing, by the user device, a wireless connection to an electronic infrared thermometer;
sending a first control signal to the electronic infrared thermometer via the wireless connection, wherein the first control signal causes the electronic infrared thermometer to activate an infrared detector to generate one or more temperature measurements;
receiving the one or more temperature measurements;
determining, by the user device, a temperature of a patient based on the one or more temperature measurements; and
outputting an indication of the temperature.

17. The non-transitory computer readable storage medium of claim 16, wherein establishing the wireless connection to the electronic infrared thermometer comprises:
detecting a first electronic infrared thermometer having a common identifier that identifies the first electronic infrared thermometer as an electronic infrared thermometer and a first unique identifier;
detecting a second electronic infrared thermometer having the common identifier and a second unique identifier;
activating one or more lights on the first electronic infrared thermometer while the first electronic infrared thermometer is indicated by the thermometer application;
activating one or more lights on the second electronic infrared thermometer while the second electronic infrared thermometer is indicated by the thermometer application;
receiving selection of the first electronic infrared thermometer or the second electronic infrared thermometer; and
establishing the wireless connection with the selected electronic infrared thermometer.

18. The non-transitory computer readable storage medium of claim 16, wherein the one or more temperature measurements comprises a plurality of digital temperature measurements, and wherein determining the temperature of the patient comprises computing an average of the plurality of digital temperature measurements.

19. The non-transitory computer readable storage medium of claim 16, the operations further comprising:
prompting a user of the electronic infrared thermometer to place the electronic infrared thermometer near a temple of the patient.

20. The non-transitory computer readable storage medium of claim 16, the operations further comprising:
sending a second control signal to the electronic infrared thermometer prior to sending the first control signal, wherein the second control signal causes the electronic infrared thermometer to transfer out of a low power state.

21. The non-transitory computer readable storage medium of claim 16, the operations further comprising:
sending a second control signal to the electronic infrared thermometer prior to sending the first control signal, wherein the second control signal causes the electronic infrared thermometer to activate two or more guide lights, wherein each of the two or more guide lights is to illuminate a point on the patient, and wherein the infrared detector detects thermal infrared radiation from an additional point between the points illuminated by the two or more guide lights.

22. The non-transitory computer readable storage medium of claim 16, wherein the one or more temperature measurements have a first unit of measurement, the operations further comprising:
determining at least one of a language setting or a location of the mobile computing device;
determining whether a second unit of measurement associated with at least one of the language setting or the location is the same as the first unit of measurement; and
responsive to determining that the first unit of measurement is different than the second unit of measurement, converting the one or more temperature measurements from the first unit of measurement to the second unit of measurement.
